(19) United States
(12) Patent Application Publication
(10) Pub. No.: US 2008/0009329 A1
(43) Pub. Date: Jan. 10, 2008

(54) Cell phone with storage area for mouth and ear pieces

(76) Inventor: Scott J. Adler, Walden, NY (US)

Correspondence Address: SUNG I. OH, PROFESSIONAL LAW CORPORATION, 710 QUAIL VALLEY LANE, WEST COVINA, CA, 91791, US

(21) Appl. No.: 11/481,995

(22) Filed: Jul. 6, 2006

(51) Int. Cl. H04B 1/38; H04M 1/00

(52) U.S. Cl. 455/575.1; 455/90.3

(57) ABSTRACT

A system stores a mouthpiece and earpiece of a cellular telephone in the telephone. The wire associated with the mouthpiece is wound up and stored, along with the mouthpiece and the earpiece, inside a compartment of the cellular telephone.

### TECHNICAL FIELD OF THE INVENTION

The present invention relates to the general art of cables and cords, and to the particular field of storing cables and cords.

### BACKGROUND OF THE INVENTION

One form of a portable telephone set comprises a main body and a cover body, wherein the cover body is hinged to the main body, so that the main and cover bodies take the position of “closed” in a non-use state and “opened” in a used state. The main body is provided with a speaker, a display, and an antenna and the cover body is provided with operation keys (buttons) and a microphone.

In the used state, the cover body is opened from the main body, and the antenna is pulled out of the main body. Thus, the speaker of the main body is placed on an ear of a user, and the microphone of the cover body is positioned in the vicinity of a mouth of the user. In this form of portable telephone set, however, size presents a disadvantage. In other words, the thickness is large, when the main and cover bodies are closed in the non-used state, and the length is large, when the main body is opened by hinging the cover body in the used state. This disadvantage has led to development of a second form of telephone set in which a main body is provided with a display, operation keys, an antenna a microphone, and an earphone.

In the second form of portable telephone set, the earphone is connected to the main body by an earphone cord, so that a speaker need not be provided. Consequently, the cover body can be eliminated to make the size of the portable telephone set small. When not using the portable telephone, the separate earpiece assembly must either be disconnected from the portable telephone/holster and stored somewhere, or loosely wrapped around or draped over the portable telephone/holster. In either case, it is a nuisance to reconnect the earpiece assembly or unwrap the earpiece assembly when placing or answering a subsequent telephone call.

There is thus a disadvantage in that the earphone cord may become tangled. Further, there is a disadvantage in that the earphone cord is difficult to manipulate, especially if the earphone cord is tangled.

### SUMMARY OF THE INVENTION

The above-discussed disadvantages of the prior art are overcome by a system which stores a mouthpiece and earpiece of a cellular telephone in the telephone. The wire associated with the mouthpiece is wound up and stored, along with the mouthpiece and the earpiece, inside a compartment of the cellular telephone.

Using the system embodying the present invention will permit a user to keep the mouthpiece and earpiece and the wire associated therewith out of the way when not in use and to keep the wire from tangling.

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWING FIGURES

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a front elevational view of a cellular telephone having the storage system embodying the present invention.

FIG. 2 is a front elevational view of another form of a cellular telephone having the storage system embodying the present invention.

### DETAILED DESCRIPTION OF THE INVENTION

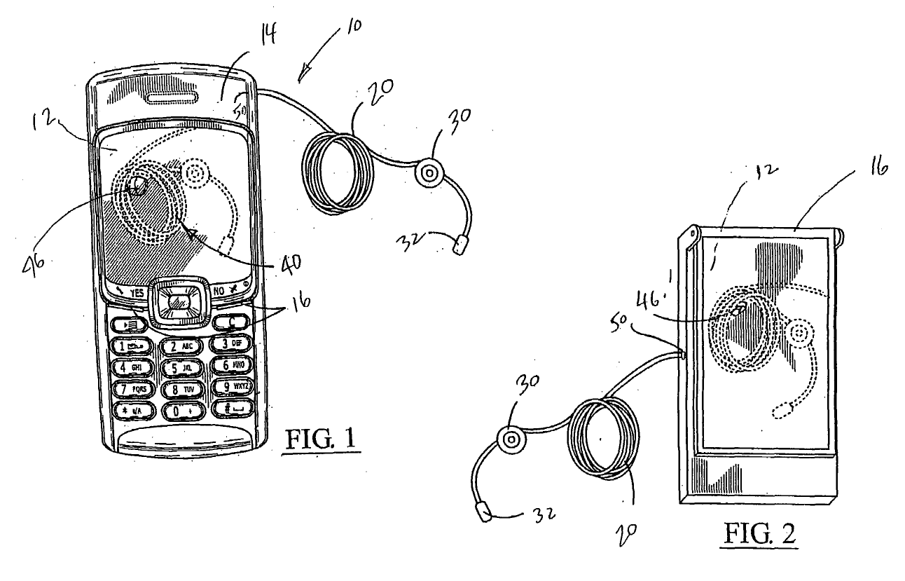

Referring to the figures, it can be understood that the present invention is embodied in a storage system 10. System 10 comprises cellular telephone housing 12 which can be a flat configuration as shown in FIG. 1 or a flip phone configuration as shown in FIG. 2. A storage compartment 12 is located in the cellular telephone housing and is covered by a door 14 that is mounted on the housing by hinges 16.

An electrical lead 20 is electrically connected to appropriate circuitry in the cellular telephone housing. An earpiece 30 is electrically connected to the lead and a mouthpiece 32 is also electrically connected to the lead to be electrically connected to the circuitry in the cellular telephone. A winding mechanism 40 is located in the storage compartment and the electrical lead is connected to the winding mechanism to be wound thereon and contained in the storage compartment when in a stored position as indicated in dotted lines in FIGS. 1 and 2. The winding mechanism includes a biasing element 46, such as a spring or the like, which biases the winding mechanism to wind the lead into the stored position. The exact details of the winding mechanism are known to those skilled in the art of winding and reeling. The exact details of the winding mechanism are not important to this invention and thus will not be disclosed or claimed.

A port 50 is defined through the cellular telephone housing, and lead 20 extends through the port when the mouthpiece and/or earpiece are to be used. The mouthpiece and the earpiece are spaced apart from the cellular telephone housing when in the use position as shown in solid lines in FIGS. 1 and 2. Lead 20 moves against the bias of the biasing element when moving from the stored position into the use position.

The lead and the mouthpiece and the earpiece can all be stored in the cellular telephone and will be easy to deploy and use when needed, yet will not tangle or be in the way during storage. The door will maintain the cord in a neatly stored, yet easily accessible, condition during storage.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

What is claimed is:

1. A storage system comprising:
A) cellular telephone housing;
B) a storage compartment in the cellular telephone housing;
C) an electrical lead electrically connected to the cellular telephone housing;
D) a storage compartment covering door;
E) a hinge connecting the storage compartment door to the cellular telephone housing;
F) an earpiece electrically connected to the lead;
G) a mouthpiece electrically connected to the lead;
H) a winding mechanism located in the storage compartment;
I) the electrical lead being connected to the winding mechanism to be wound thereon and contained in the storage compartment when in a stored position, the winding mechanism including a biasing element which biases the winding mechanism to wind the lead into the stored position;
J) a port on the cellular telephone housing; and
K) the lead extending through the port and the mouthpiece and the earpiece being spaced apart from the cellular telephone housing when in the use position, the lead moving against the bias of the biasing element when moving from the stored position into the use position.

2. The storage system defined in claim 1 wherein the cellular telephone is a flip phone.
